(19) United States
(12) Patent Application Publication
(10) Pub. No.: US 2026/0233424 A1
(43) Pub. Date: Aug. 13, 2026

(54) SHAVING CARTRIDGE

(71) Applicant: The Gillette Company LLC, Boston, MA (US)

(72) Inventors: Jahdiel Fyfield, Roslindale, MA (US); Christopher Ramm, North Attleboro, MA (US); Lindsey McLane Sharlow, Boston, MA (US); Anthony Stephen Wilkinson, Somerville, MA (US)

(21) Appl. No.: 19/049,178

(22) Filed: Feb. 10, 2025

(51) Int. Cl. B26B 21/44; B26B 21/40; B26B 21/22

(52) U.S. Cl. CPC B26B 21/443; B26B 21/4018; B26B 21/4025; B26B 21/4031; B26B 21/225

(57) ABSTRACT

A shaving cartridge with a housing defining a first pocket, a second pocket and a window dimensioned to receive one or more blades. The housing having a leading platform. A blade mounted within the window. A guard in front of the blade. A cap behind the blade. The leading skin bar includes a shaving aid composition. The leading skin bar is mounted to a first surface of the leading platform. The shaving aid composition extends from the first surface into a second through hole of the first pocket, and into the first pocket. The second through hole extends in a direction between the guard and the cap.

### FIELD OF THE INVENTION

The present invention relates to shaving razors and more particularly to shaving cartridges having a housing and a lubrication member secured to the housing.

### BACKGROUND OF THE INVENTION

In general, shaving razors of the wet shave type include a cartridge or blade unit with at least one blade with a cutting edge, which is moved across the surface of the skin being shaved by means of a handle to which the cartridge is attached. The cartridge may be mounted detachably on the handle to enable the cartridge to be replaced by a fresh cartridge when the blade sharpness has diminished to an unsatisfactory level, or it may be attached permanently to the handle with the intention that the entire razor be discarded when the blade or blades have become dulled. Shaving cartridges usually include a guard which contacts the skin in front of the blade(s) and a cap for contacting the skin behind the blade(s) during shaving. The cap and guard aid in establishing the so-called "shaving geometry", i.e., the parameters which determine the blade orientation and position relative to the skin during shaving, which in turn have a strong influence on the shaving performance and efficacy of the razor. The guard may be generally rigid, for example formed integrally with a frame or platform structure which provides a support for the blades.

In the use of shaving razors of the wet shave type, factors such as frictional drag of the razor across the skin, force needed to sever hairs, and irritation or pre-existing skin damage can create a degree of shaving discomfort. Shaving aids, e.g., a lubricant, whisker softener, razor cleanser, medicinal agent, cosmetic agent or combination thereof, have been incorporated into razors, for example by incorporating a shaving aid into one or more extruded or molded polymeric components of the razor. Such shaving aid composites may be mounted on the cap or guard structures of the shaving cartridge. Upon exposure to water, water-soluble shaving aid leaches from the composite onto the skin and the composite tends to swell.

The shaving aid composites must be positively secured for effective dispensing throughout the useful shaving life of the razor. Forces during shaving may contribute to loosening of the shaving aid components from the cartridge. In addition, consumers may store the wet shaving cartridge on bathroom tub or countertop after shaving. Accordingly, the wet shaving aid components may become stuck to the bathroom tub or countertops. The consumer may then damage the shaving aid or the cartridge when attempting to remove the cartridge from the countertop or bathroom tub. Numerous extruded or molded shaving aid components have been developed which are secured to the shaving cartridge with adhesives. These arrangements have been unsatisfactory for certain applications. Adhesives are typically a poor choice for several reasons. Adhesives are difficult to work with from a manufacturing perspective and are also susceptible to changes in heat and humidity.

In certain countries, shaving razors are exposed to constant high levels of heat and humidity during shipment and storage. These levels of heat and humidity can adversely affect the adhesive properties such that the lubrication component is no longer secured. Various press-fit type designs have also been developed to secure the shaving aid component to the cartridge of the shaving razor. The various press-fit type designs have also proven to be ineffective in certain applications. Press-fit designs rely on a significant amount of force to be applied to the shaving aid composite in order to properly secure the shaving aid composite within the housing, which may cause the shaving aid composite to break or fracture. These designs are also not very effective because they do not accommodate for changing forces resulting from the shaving aid composite swelling and expanding. These cartridge designs also rely on an increased surface contact area with the shaving aid composite to better secure the shaving aid composite to the cartridge, which limits the cartridge design, such as the size of the cartridge and the placement of the blade(s).

What is needed, then, is a wet shaving cartridge having lubrication member that is secured to the cartridge that accounts for water absorption and swelling without negatively impacting shaving performance or the securement of the lubrication member to the housing. It may also be desirable to provide a manufacturing method for assembling a lubrication member that accounts for tolerance variations without negatively impacting shaving performance. The wet shaving cartridge assembly is preferably simpler, cost-effective, reliable, durable, easier and/or faster to manufacture, and easier and/or faster to assemble with more precision.

### SUMMARY OF THE INVENTION

In one aspect, the invention features, in general, shaving cartridge with a housing defining a first pocket, a second pocket and a window dimensioned to receive one or more blades. The housing has a trailing platform. A blade mounted within the window. A guard in front of the blade. A cap behind the blade. A trailing skin bar includes a shaving aid composition. The trailing skin bar is mounted to a first surface of the trailing platform. The shaving aid composition extends from the first surface into a first through hole of the first pocket and into the first pocket. The first through hole extends in a direction between the guard and the cap.

In another aspect, the invention features, in general, a shaving cartridge with a housing defining a first pocket, a second pocket and a window dimensioned to receive one or more blades. The housing having a leading platform. A blade mounted within the window. A guard in front of the blade. A cap behind the blade. The leading skin bar includes a shaving aid composition. The leading skin bar is mounted to a first surface of the leading platform. The shaving aid composition extends from the first surface into a second through hole of the first pocket, and into the first pocket. The second through hole extends in a direction between the guard and the cap.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings.

FIG. 1 is top view of one possible embodiment of a shaving cartridge.

FIG. 2 is a cross section view of the shaving cartridge, taken generally along the line 2-2 of FIG. 1.

FIG. 3 is a bottom view of a housing of the shaving cartridge of FIG. 1.

FIG. 4 is a top view of a housing of the shaving cartridge of FIG. 1.

FIG. 5 is a bottom view of a housing of the shaving cartridge of FIG. 1.

FIG. 6 is a top view of a housing of the shaving cartridge of FIG. 1.

FIG. 7 is a bottom view of the shaving cartridge of FIG. 1.

### DETAILED DESCRIPTION OF THE INVENTION

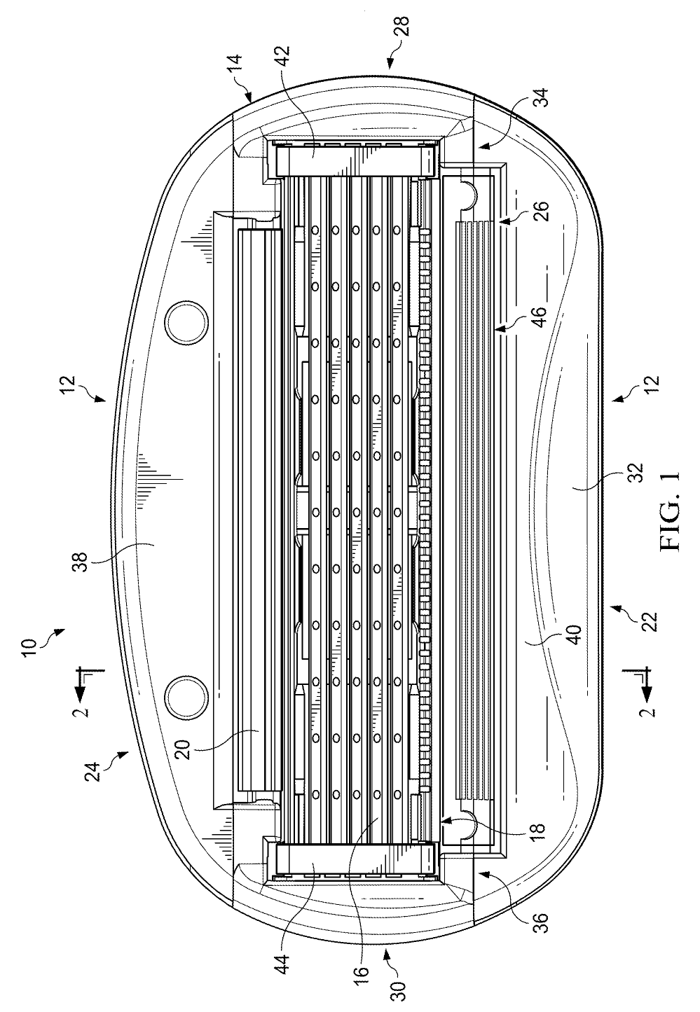

Referring to FIG. 1, one possible embodiment of the present disclosure is shown illustrating a shaving cartridge 10. In certain embodiments, the shaving blade cartridge 10 may be detached and removed from a handle (not shown). The shaving blade cartridge 10 may be fixedly or pivotably mounted to the handle depending on the overall desired cost and performance. The shaving cartridge 10 may also include an interconnect member (not shown) to which the shaving cartridge 10 is pivotably mounted about a pivot axis. As will be described in greater detail below, the shaving cartridge 10 may include a shaving aid composition 12 that is mounted to a housing 14 at a front and/or rear portion of the shaving cartridge 10. The housing 14 may carry one or more blades 16, a guard 18 and a cap 20. Although five blades 16 are illustrated, it is understood that more or less blades 16 may be mounted to the housing 16 depending on the desired cost and performance of the shaving cartridge 10.

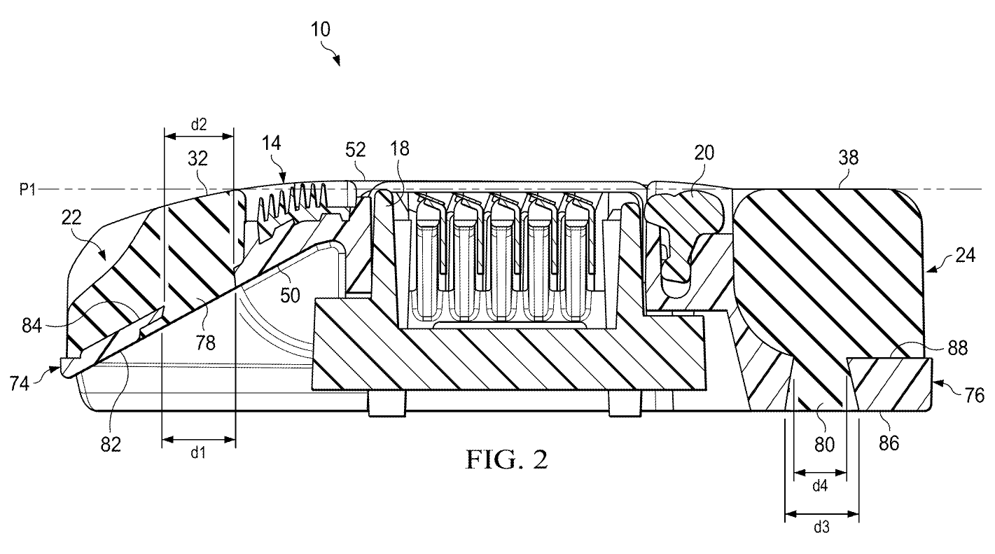

A leading skin bar 22 may be positioned in front of the guard 18 and a trailing skin bar 24 may be positioned behind the cap 20. The leading skin bar 22 and/or the trailing skin bar 24 may comprise the shaving aid composition 12 (e.g., a water leachable shaving aid composition). The one or more blades 16 may be positioned between the guard 18 and the cap 20. The guard 18 and the cap 20 may define a shaving plane P1 (see FIG. 2). In certain embodiments, an elastomeric member 26 may be mounted to the housing 14 between the guard 18 and the leading skin bar 22 (i.e., in front of the guard 18 and behind the leading skin bar 22). The elastomeric member 26 include a plurality of protrusions, such as fins, to improve skin stretching during a shaving stroke. The guard 18 may be a continuous bar, as shown, or segmented to facilitate alignment of hair during a shaving stroke. The housing 18 may be molded from semi-rigid polymers having a Shore A hardness of about 50, 60, or 70 to about 90, 110, or 120.

The leading skin bar 22 and/or the trailing skin bar 24 may be molded to the housing 14 using insert injection molding (two-shot molding) or insert injection molding. The leading skin bar 22 and/or the trailing skin bar 24 may be molded from the shaving aid composition 12 having one or more water-leachable shaving aid materials to provide increased comfort during shaving (e.g., lubrication, moisturization and/or other skin benefits). One or more layers of the shaving aid composition 12 may be molded to the housing 14 to form the leading skin bar 22 and/or the trailing skin bar 24. The shaving aid composition 12 comprise one or more polymeric materials. For example, the shaving aid composition 12 may include a water-insoluble polymer material comprising ethylene vinyl acetate (EVA) and combined with a water-soluble polymer material and other optional adjunct or secondary ingredients to provide one or more skin benefits, such as increased lubrication and improve skin moisturization.

Additional water-insoluble polymers can also be used, in addition to the EVA. Examples of additional water-insoluble polymers include those known in the art and used in skin engaging members found on razors today. Specific water-insoluble polymers which can be used include polyethylene (PE), polypropylene, polystyrene (PS), butadiene-styrene copolymer (e.g. medium and high impact polystyrene), polyacetal, acrylonitrile-butadiene-styrene copolymer, ethylene vinyl acetate copolymer, polyurethane, and blends thereof, such as polypropylene/polystyrene blend or polystyrene/impact polystyrene blend. These matrix polymers can also be free or essentially free of one of more of these additional water-insoluble polymers.

Suitable water soluble polymers which can be used in accordance with the present invention include, but are not limited to, one or more of: a polyethylene oxide, polyvinyl pyrrolidone, polyacrylamide, polyhydroxymethacrylate, polyvinyl imidazoline, polyethylene glycol, polyvinyl alcohol, polyhydroxyethymethacrylate, silicone polymers, and mixtures thereof. In one embodiment, said water soluble polymer is selected from the group consisting of polyethylene oxide, polyethylene glycol, and a mixture thereof.

In certain embodiments, the shaving aid composition 12 may comprise other ingredients commonly found in commercially available skin engaging members, such as those used on shaving cartridges by GILLETTE, SCHICK or BIC. Non-limiting examples of such skin engaging members include those disclosed in U.S. Pat. Nos. 6,301,785, 6,442,839, 6,298,558, 6,302,785, and U.S Patent Pubs 2008/060201, and 2009/0223057. In one embodiment, the skin engaging member further comprises a skin engaging member ingredient selected from the group consisting of polyethylene oxide, polyvinyl pyrrolidone, polyacrylamide, hydroxypropyl cellulose, polyvinyl imidazoline, polyethylene glycol, poly vinyl alcohol, polyhydroxyethylmethacrylate, silicone copolymers, sucrose stearate, vitamin E, soaps, surfactants, panthenol, aloe, plasticizers, such as polyethylene glycol; beard softeners; additional lubricants, such as silicone oil, TEFLON® polytetrafluoroethylene powders (manufactured by DuPont), and waxes; essential oils such as menthol, camphor, eugenol, eucalyptol, safrol and methyl salicylate; tackifiers such as Hercules Regalrez 1094 and 1126; non-volatile cooling agents, inclusion complexes of skin-soothing agents with cyclodextrins; fragrances; antipruritic/counterirritant materials; antimicrobial/keratolytic materials such as Resorcinol; anti-inflammatory agents such as Candilla wax and glycyrrhetinic acid; astringents such as zinc sulfate; surfactants such as pluronic and iconol materials; compatibilizers such as styrene-b-EO copolymers; mineral oil, polycaprolactone (PCL), and combinations thereof.

The shaving aid composition may include one or more skin lubricating water-soluble polymers such as, polyethylene oxide, polyvinyl pyrrolidone, polyacrylamide, hydroxypropyl cellulose, polyvinyl imidazoline, and polyhydroxyethylmethacrylate. Other water-soluble polymers may include the polyethylene oxides generally known as POLYOX (available from Dow Chemical) or ALKOX (available from Meisei Chemical Works, Kyota, Japan). These polyethylene oxides may have molecular weights of about 100,000 to 6 million, for example, about 300,000 to 5 million. The polyethylene oxide may comprise a blend of about 40 to 80% of polyethylene oxide having an average molecular weight of about 5 million (e.g., POLYOX COAGULANT) and about 60 to 20% of polyethylene oxide having an average molecular weight of about 300,000 (e.g., POLYOX WSR-N-750). The polyethylene oxide blend may also contain up to about 10% by weight of a low molecular weight (i.e., MW<10,000) polyethylene glycol such as PEG-100.

The shaving aid composite may also optionally include an inclusion complex of a skin-soothing agent with a cylcodextrin, low molecular weight water-soluble release enhancing agents such as polyethylene glycol (e.g., 1-10% by weight), water-swellable release enhancing agents such as cross-linked polyacrylics (e.g., 2-7% by weight), colorants, antioxidants, preservatives, microbicidal agents, beard softeners, astringents, depilatories, medicinal agents, conditioning agents, moisturizers, cooling agents, etc.

The molding of the leading skin bar 22 and/or the trailing skin bar 24 may allow for a greater variety of shapes (e.g., compared to extruded lubrication bars that are later assembled to a shaving cartridge housing) and different surface textures to be added. However, it may be difficult to secure the leading skin bar 22 and/or the trailing skin bar 24 the housing 14 using common assembly techniques because exposure of water leachable shaving aids to water, may cause the leading skin bar 22 and/or the trailing skin bar 24 to swell and adhere to a resting surface, such as a sink or bathroom counter, which may cause the leading skin bar 22 and/or the trailing skin bar 24 to separate from the housing 14. In the past, the ability to use certain materials that may have provided improved skin benefits was limited because these materials were typically softer, such as soaps and wax-like compositions, thus making it difficult to retain the materials on a shaving cartridge over multiple shaves.

In certain embodiments, the leading skin bar 22 and the trailing skin bar 24 may spaced apart by a portion of the housing 14 (e.g., lateral ends 28 and 30 of the housing 14), when viewed from a top of the shaving cartridge 10. The leading skin bar 22 may have an upper skin contacting surface 32 and an opposing bottom surface (not shown). The upper skin contacting surface 32 may have an may have a generally U-shaped profile to provide improved glide and a more comfortable feel against the skin of the user (e.g., compared to an extruded lubrication strip). For example, the upper skin contacting surface 32 may extend beyond the elastomeric member 26 (e.g., elastomeric member 26 may be positioned between lateral portions 34 and 36 of the upper skin contacting surface 32 of the leading skin bar 22). The shaving aid composition of the upper skin contacting surface 32 may be completely exposed to maximize the amount of shaving aid composition delivered to the skin surface during a shaving stroke.

The trailing skin bar 24 may have an upper skin contacting surface 38 and an opposing bottom surface (not shown). In certain embodiments, the upper skin contacting surface 38 may be generally flat and parallel to a shaving plane P1 defined by the guard 18 and the cap 20 (FIG. 2). As will be described in greater detail below, the upper skin contacting surface 32 of the leading bar may be spaced apart from the upper skin contacting surface 38 of the trailing skin bar; however, the leading skin bar 22 may be interconnected to the trailing skin bar 24 at respective opposing non skin contacting surfaces (not shown).

The upper skin contacting surface 32 may have an elongated portion 40 in front of the elastomeric member 30. The elongated portion 40 may extend parallel to the at least one blade 16. The pair of lateral ends 34 and 36 may extend from the elongated portion 40 toward the at least one blade 16. The pair of lateral ends 34 and 36 may extend transverse to the at least one blade 20 and/or the elongated portion 44 of the upper skin contacting surface 40 (i.e., toward the cap 20). In certain embodiments, upper skin contacting surface 32 may be smooth. However, other embodiments might include the use text, texture, pattern, lines, icons, or channels to promote a particular aesthetic or functional benefit, for example, skin stretching of tactile feel on the skin.

The one or more blades 16 may be mounted within the housing 14 and secured with one or more clips 42 and 44. The clips 42 and 44 may be parallel to each other and may extend into the housing to secure the blades 16 to the housing 14. Other assembly methods known to those skilled in the art may also be used to secure the one or more blades 16 to the housing 14 including, but not limited to wire wrapping, cold forming, hot staking, insert molding, and adhesives. The lateral ends 34 and 36 of the leading skin bar may be positioned directly in front of (e.g., immediately adjacent) the clips 42 and 44 Accordingly, glide may be enhanced because lubricants released from the leading skin bar 22 may be deposited directly onto the metallic clips 42 and 44 during a shaving stroke.

In certain embodiments, the elastomeric member 26 may have a plurality of protrusions 46 (e.g., fins 46) between the at least one blade 16 and the leading skin bar 22 to stretch the skin for providing a closer shave. The protrusions 46 may extend generally parallel to the at least one blade 16 and/or the elongated portion 40 of the upper skin contacting surface 32 on the leading skin bar 22. The elastomeric member 26 may be positioned between the lateral ends lateral end 34 and 36.

Referring to FIG. 2, a cross sectional view of the shaving blade cartridge 10 is illustrated, taken generally along the line 2-2 of FIG. 1. The guard 18 and the cap 20 may define the shave plane P1. The housing 14 may have a first surface 50 and an opposing second surface 52. The first surface 50 may be opposite the guard 18, the cap 20 and the blades 16 that define the shaving surface. Accordingly, the first surface 50 may face away from the skin during a shaving stroke and the second surface 52 may face the skin during a shaving stoke. The guard 18 and/or the cap 20 may be part of the second surface 52. As will be explained in greater detail below, the leading skin bar 22 and the trailing skin bar 24 may be mounted to the second surface 52. As will be explained in greater detail below, the leading skin bar 22 and/or the trailing skin bar 24 may extend through the second surface 52 to the first surface 50 to aid in retaining the leading skin bar 22 and/or the trailing skin bar 24 to the housing 14.

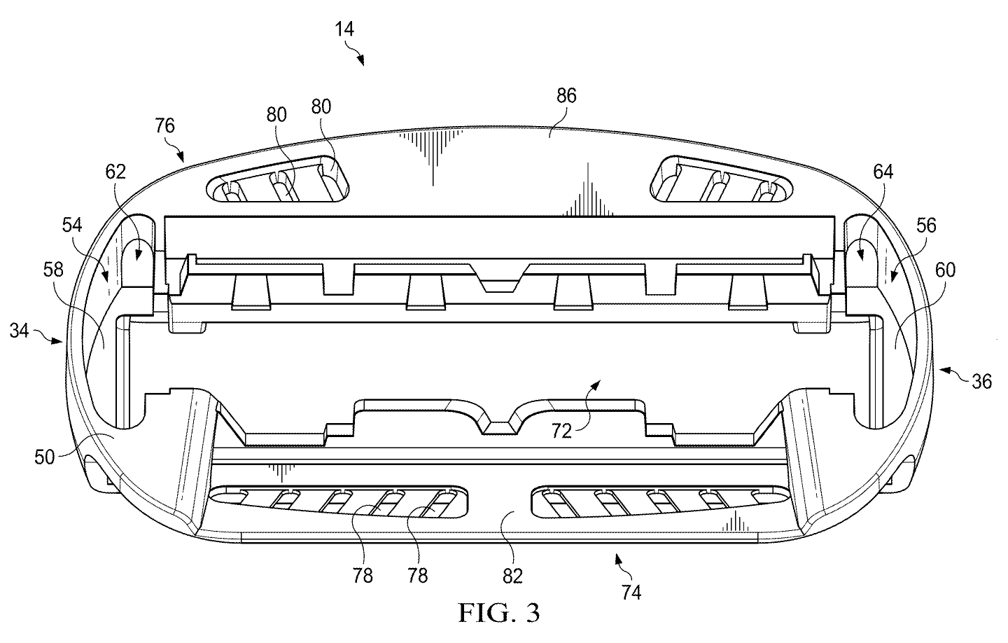

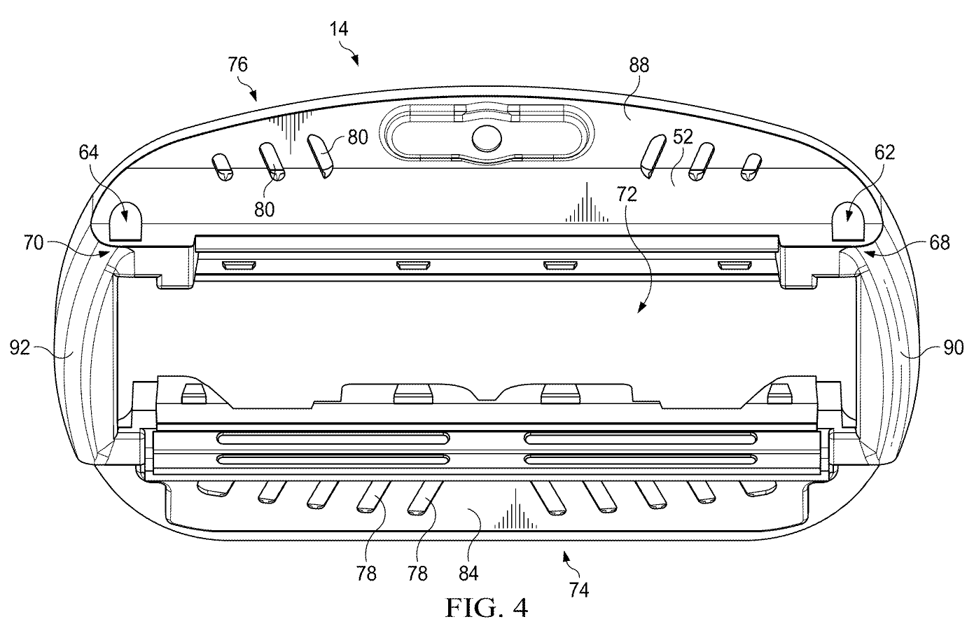

Referring to FIG. 3, a bottom, front perspective view of the housing 14 is illustrated with various components removed for clarity (e.g., the blades 16, the leading skin bar 22, the trailing skin bar 24 and the clips 42 and 44). Similarly, FIG. 4 is a top, perspective view of the housing 14 with various components of the shaving blade cartridge 10 removed for clarity (e.g., the blades 16, the leading skin bar 22, the trailing skin bar 24 and the clips 42 and 44). FIG. 3 illustrates the first surface 50 of the housing 14 and the opposing second surface 52 is illustrated in FIG. 4. The first surface 50 may be opposite the guard 18, the cap 20 and the blades 16 that define the shaving plane P1 of FIG. 2.

The first surface 50 may define a first pocket 54 and a second pocket 56. The first pocket 54 and the second pocket 56 may be positioned at the corresponding lateral ends 34 and 36 of the housing 14. The first pocket 54 may extend from the first surface 50 to a first platform 58, which may support the shaving aid composition 12 (FIGS. 1 and 2). The second pocket 56 may extend from the first surface 50 to a second platform 60, which may support the shaving aid composition 12 (FIGS. 1 and 2). The first pocket 54 and the second pocket 56 may each have a depth of about 4 mm to about 7 mm and preferably about 5 mm to 6 mm (i.e., distance between first surface 50 and the corresponding platforms 54 and 56). The shaving aid composition 12 (FIG. 1 and 2) may be formed within the first pocket 54 and the second pocket 56. The first platform 58 and the second platform 60 may separate the shaving aid composition 12 (FIG. 1 and 2) from the second surface 52 (i.e., top surface) of the housing 14. In certain embodiments the first pocket 54 may contain the shaving aid composition 12 (FIG. 1 and 2) having a volume greater than or equal to 50 mm³, for example, of 50 mm³ to about 200 mm³, and preferably about 75 mm³ to 150 mm³ . In certain embodiments the second pocket 56 may contain the shaving aid composition 12 (FIG. 1 and 2) having a volume greater than or equal to 50 mm³, for example, of 50 mm³ to about 200 mm³, and preferably about 75 mm³ to about 150 mm³ . The first pocket 54 and the second pocket 56 may provide for a sufficient volume of the shaving aid composition 12 (FIG. 1 and 2) to anchor the leading skin bar 22 and the trailing skin bar 24 to the housing 14. In certain embodiments, trailing skin contacting bar 24 may have a volume that is greater than the leading skin contacting bar 22. It is believed, without being held to theory, that a larger volume of shaving aid may be more desirable behind the blades 16 because the blades 16 wipe away a significant amount of any pre-shave lotion applied to the skin. The leading skin contacting bar 22 may have a volume of about 200 mm³ to about 600 mm³ and preferably about 300 mm³ to about 500 mm³. The trailing skin contacting bar 24 may have a volume of about 400 mm³ to 1000 mm³ and preferably about 500 mm³ to about 900 mm³. In certain embodiments, the combined volume of the shaving aid composition 12 (FIGS. 1 and 2) of the leading skin contacting bar 22 and the trailing skin contacting bar 24 may be about 600 mm³ to 1600 mm³ and preferably about 1000 mm³ to 1400 mm³ to deliver the optimal level of lubrication and moisturization to the skin over an extended number of shaves.

The housing 14 may define a first through hole 62 in communication within the first pocket 54. The first through hole 62 may extend in a direction between the guard 18 and the cap 20 (FIGS. 1 and 2). The first through hole 62 may be enclosed to further aid in retention of the shaving aid composition within the first pocket 54. The housing 14 may also define a first through hole 64 in communication within the second pocket 56. The first through hole 64 may extend in a direction between the guard 18 and the cap 20 (e.g., a front to rear direction of the housing 14). The first through hole 64 may be enclosed to further aid in retention of the shaving aid composition 12 (FIGS. 1 and 2) within the second pocket 56. The first through holes 62 and 64 may extend to the second surface 52 (FIG. 4). A portion 68 of the second surface 52 may cover the first through hole 62 and a portion 70 of the second surface may cover the first through hole 64, as shown in FIG. 4, which may further help retain the shaving aid composition 12 (FIGS. 1 and 2). It is understood the through holes 62 and/or 64 may alternatively extend transverse to the direction between the cap 20 and the guard 18. However, this may require increasing the size of the first pocket 54 and/or the second pocket 56, which may also increase the overall size of the housing 14 and the shaving cartridge 10.

The housing 14 may define a window 72 for receiving the one or more blades 16 (FIG. 1). The housing 14 may include a leading platform 74 in front of the window 72 that supports the leading skin bar 22 (FIGS. 1 and 2). The housing 14 may also include a trailing platform 76 behind the window 72 that supports the trailing skin bar 24, as shown in FIGS. 1 and 2. In certain embodiments, the leading platform 74 and/or the trailing platform 76 may be flexible. For example, the leading platform 74 and/or the trailing platform may pivot relative to each other and/or the housing 14 during a shaving stroke. Alternatively, the leading platform 74 and/or the trailing platform 76 may be fixed relative to each other and/or the remainder of the housing 14 during a shaving stroke. The leading platform 74 may define a plurality of through openings 78 and the trailing platform 76 may define a plurality of through openings 80. Accordingly, the through openings 78 may facilitate transferring the shaving aid composition 12 from a first surface 82 (FIGS. 2 and 3) of the leading platform 74 to a second opposing surface 84 (FIGS. 2 and 4) of the leading platform 74. Similarly, the through openings 80 may facilitate transferring the shaving aid composition from a first surface 86 (FIGS. 2 and 3) of the trailing platform 76 to a second opposing surface 88 (FIGS. 2 and 4) of the trailing platform 76. In certain embodiments, the shaving aid composition 12 does not cover the first surface 86 of the trailing platform 76 that faces away from the shave plane P1 (FIG. 2). In certain embodiments, the shaving aid composition may completely cover the second opposing surface 88 (FIG. 2) of the trailing platform 76 which faces the shave plane P1. The through openings 78 and 80 may be circular or oblong in shape; however, it is understood other shapes such as polygons are possible.

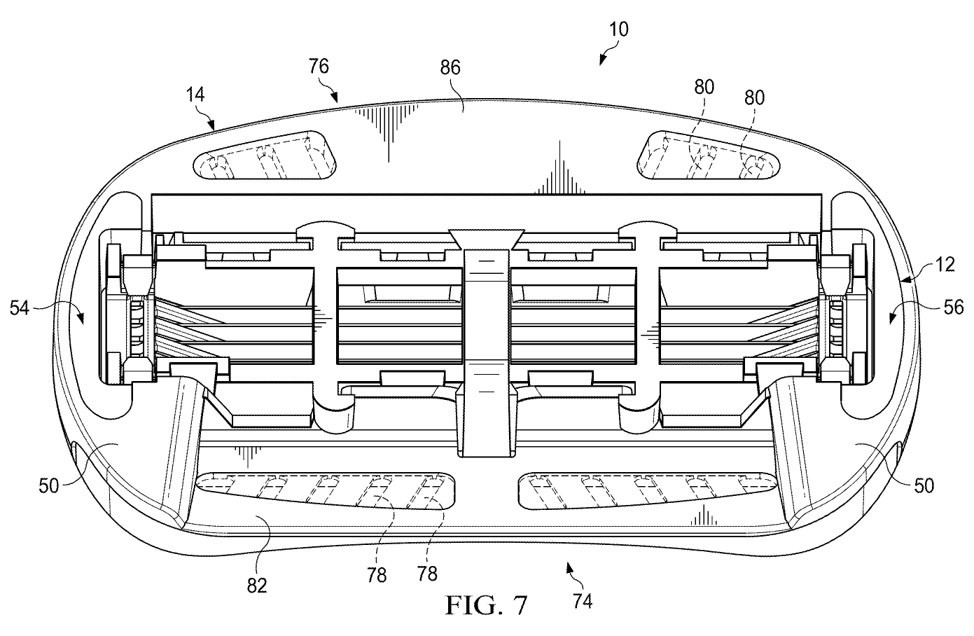

In certain embodiments, the openings 80 may be positioned within a recess defined by the first surface 86, as shown in FIG. 3. Accordingly, the housing 14 may be sandwiched between shaving aid composition on the first surface 86 (e.g., within the recess) and shaving aid composition on the second surface 88 (FIGS. 4 and 7) of the trailing platform 76. Similarly, the openings 78 (FIG. 3) may be positioned within a recess defined by the first surface 82 of the leading platform 74. Accordingly, the housing 14 may be sandwiched between shaving aid composition on the first surface 82 (e.g., within the recess) and shaving aid composition on the second surface 84 of the leading platform 74 (FIGS. 4 and 7). The positioning of the housing 14 between opposing surfaces of the shaving air composition may provide for a more robust attachment of the shaving aid composition, especially over an extended period of use.

The first through hole 62 of the first pocket 54 and the first through hole 64 of the second pocket 56 may facilitate the transfer of the shaving aid composition from the respective pockets 54 and 56 to the second surface 88 of the trailing platform 76, thus forming the trailing skin bar 24 (FIGS. 1 and 2). As shown in FIG. 4, the housing 14 may have a pair of cover surfaces 90 and 92 that extend over the respective pockets 54 and 56, as well as the through holes 62 and 64 (FIG. 3), thus facilitating the retainment of the shaving aid composition within the pockets 54 and 56 and securing the trailing skin bar 24 to the housing 14 (FIG. 1). For example, the shaving aid composition 12 may fill the first pocket 54 and the second pocket 56 (FIG. 7). The shaving aid composition may travel through the first through holes 62 and 64 to the second surface 88 of the trailing platform 76. The shaving aid composition may cover the second surface 88 of the trailing platform 76 and flow from the second surface 88 into the through openings 80 (FIG. 2). In certain embodiments, the shaving aid composition 12 may flow into the through openings 80 but may not cover the first surface 86 (FIG. 3) of the trailing platform 76 (e.g., as shown in FIG. 7). The openings 80 may help in retaining the shaving aid composition (i.e., the trailing skin bar 24 to the trailing platform 76).

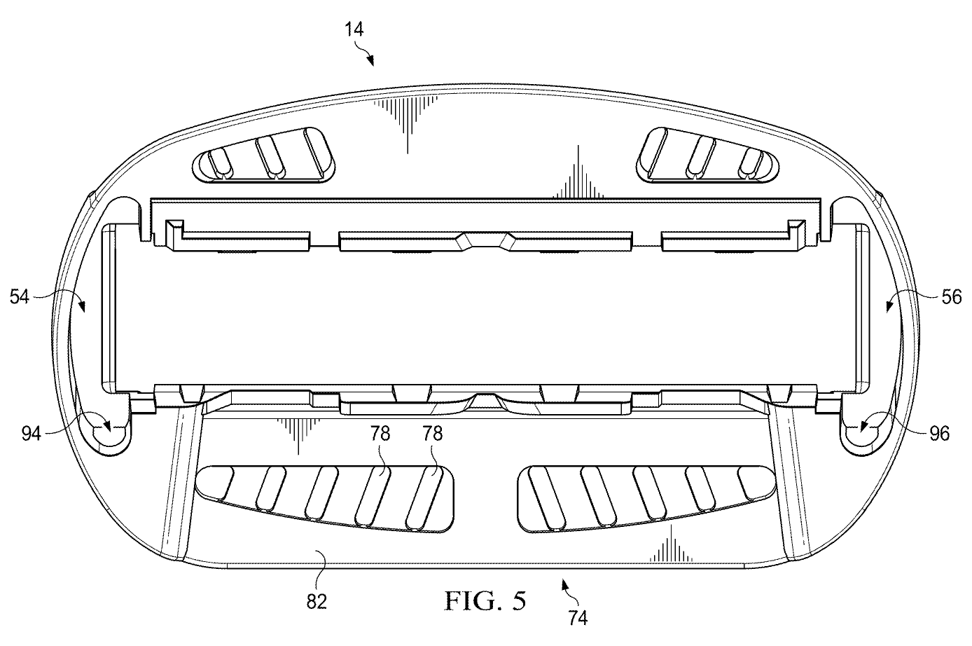

Referring back to FIG. 2, the through openings 78 and 80 may extend in a direction substantially perpendicular to the shave plane P1. The through openings 78 and 80 may also extend in a direction substantially perpendicular to the through holes 62, 64, 94 and 96 (FIGS. 4 and 5). In certain embodiments, the through openings 78 and 80 may be dimensioned to retain the shaving aid composition. For example, a dimension d1 of the through opening 78 of the leading platform 74 may be greater at the first surface 82 compared to a dimension d2 of the though opening 78 at the second opposing surface 84. Similarly, a dimension d3 of the through opening 80 of the trailing platform 76 may be greater at the first surface 86 compared to a dimension d4 of the though opening 80 at the second opposing surface 88. Accordingly, a significant amount of force is required to lift the shaving aid composition off of the leading platform 74 and the trailing platform 76 (i.e., toward the shave plane P1) due to the reverse taper of the through openings 78 and 80.

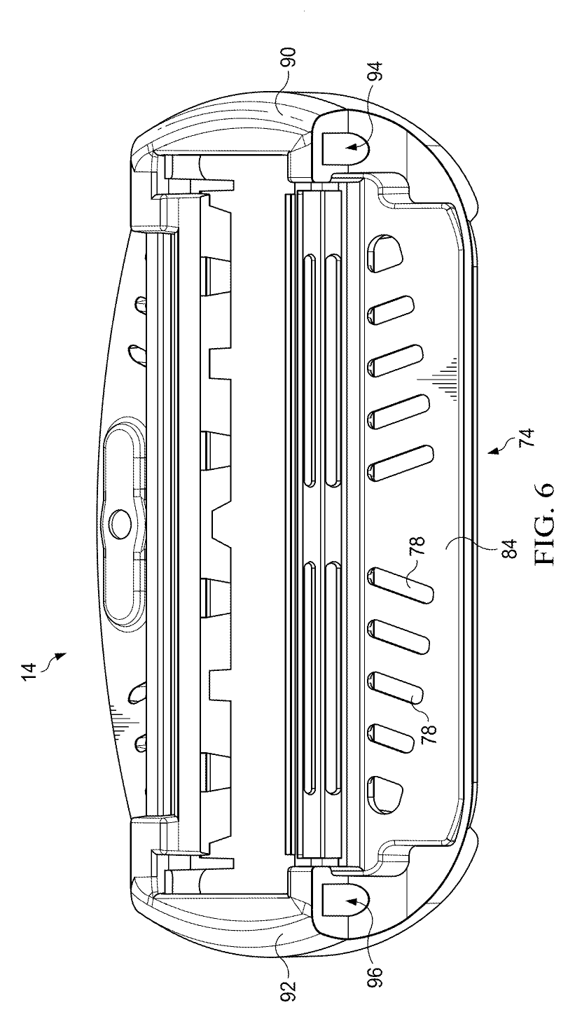

As shown in FIG. 5, the housing 14 may define a second though hole 94 extending into the first pocket 54. The housing 14 may also define a second through hole 96 extending into the second pocket 56. The second through hole 94 of the first pocket 54 and the second through hole 96 of the second pocket 56 may facilitate the transfer of the shaving aid composition from the respective pockets 54 and 56 to the second surface 84 (FIG. 6) of the leading platform 74, thus forming the leading skin bar 24 (FIGS. 1 and 2). For example, the shaving aid composition may fill the first pocket 54 and the second pocket 56. The shaving aid composition may travel through the second through holes 94 and 96 to the second surface 84 of the leading platform 74 (FIG. 6). The shaving aid composition may cover the second surface 84 (FIG. 6) of the leading platform 74, then flow from the second surface 84 through the openings 78. In certain embodiments, the shaving aid composition may flow through the openings 78 but may not cover the first surface 82 (FIG. 5) of the leading platform 74. The openings 78 may help in retaining the shaving aid composition (i.e., the leading skin bar 22 to the leading platform 74). It is understood the second through holes 94 and/or 96 may alternatively extend transverse to the direction between the cap 20 and the guard 18. However, this may require increasing the size of the first pocket 54 and/or the second pocket 56, which may also increase the overall size of the housing 14 and the shaving cartridge 10. It is also understood that although two openings 62, 64, 94 and 96 as illustrated for each of the first pocket 54 and the second pocket 56, each of the first pocket 54 and/or the second pocket 56 may have just one of the openings 62, 64, 94 and 96. However, each of the first pocket 54 and the second pocket 56 having a pair of the openings 62, 64, 94 and 96 may not only increase the retention of the shaving aid composition 12 to the housing 10, but facilitates transfer of the shaving aid composition in front of the blade(s) 16 (e.g., the leading skin bar 22) and the behind the blade(s) 16 (e.g., the trailing skin bar 24).

The first through holes 62 and 64 second through holes 94 and 96 may allow for the leading skin bar 22 and the trailing skin bar 24 to be formed together as a single unit. For example, a single injection of the shaving aid composition may be used to create both the leading skin bar 22 and the trailing skin bar 24 simultaneously. Accordingly, the first through holes 62 and 64 second through holes 94 and 96 interconnect the leading skin contacting bar 22 and the trailing skin contacting bar 24.

Referring to FIG. 7, a bottom view of the shaving cartridge 10 of FIG. 1 is illustrated. In certain embodiments, the shaving aid composition 12 may be secured within the pockets 54 and 56 and the to the housing 14. The shaving aid composition 12 may not extend out of the pockets 54 and 56 (e.g., above the first surface 50 of the housing 14) to account for any swelling of the shaving aid composite 12. The flow through the openings 80 but may not cover the first surface 86 of the trailing platform 76. Similarly, the shaving aid composition 12 may flow through the openings 78 but may not cover the first surface 82 of the leading platform 74. In certain embodiments, the shaving aid composition 12 may be recessed within the first pocket 54, the second pocket 56, the through openings 78 and/or the through openings 80 for aesthetics and to minimize waste.

It is understood the shaving cartridge 10 need not include both the leading skin bar 22 and the trailing skin bar 24 (FIGS. 1 and 2). The shaving cartridge 10 may include one of the desired leading skin bar 22 and the trailing skin bar 24. Thus, the housing 14 may include one of the leading platform 74 and the trailing platform 76 to support the respective leading skin bar 22 and the trailing skin bar 24. In certain embodiments, it may be desired to have only one of the leading skin bar 22 and the trailing skin bar 24 or it may be desired to have a different shaving aid composition for the leading skin bar 22 than the trailing skin bar 24, which may be accomplished by having only one of the through openings 62, 64, 94 and 96 in the respective first pocket 54 and the second pocket 56. The first pocket 54 may only have one of the through openings 62 and 94 and the second pocket 56 to have only one of the through openings 64 and 96. For example, the first pocket 54 may only have the through opening 62 leading to the trailing platform 76 and the second pocket 56 may only have the through opening 96 extending to the leading platform 74. Accordingly, the first pocket 54 and the trailing skin bar 24 supported by the trailing platform 76 may include a first shaving aid composition and the second pocket 56 and the trailing skin bar 22 supported by the leading platform 74 may include a second shaving aid composition that is different than the first shaving aid composition.

### Representative Examples

A. A shaving cartridge comprising a housing defining a first pocket, a second pocket and a window dimensioned to receive one or more blades, the housing having a trailing platform; a blade mounted within the window; a guard in front of the blade; a cap behind the blade; a trailing skin bar comprising a shaving aid composition mounted to a first surface of the trailing platform, the shaving aid composition extends from the first surface into a first through hole of the first pocket, and into the first pocket, wherein the first through hole extends in a direction between the guard and the cap.

B. The shaving cartridge of paragraph A wherein the shaving aid composition extends from the first surface into a first through hole of the second pocket and into the second pocket.

C. The shaving cartridge of any one of paragraphs A-B wherein the trailing platform defines a plurality of through openings that extend in a direction substantially perpendicular to the direction of the first through holes.

D. The shaving cartridge of any one of paragraphs A-C wherein the guard and the cap define a shaving plane and the shaving aid composition does not cover a first surface of the trailing platform that faces away from the shave plane.

E. The shaving cartridge of any one of paragraphs A-C wherein the shaving aid composition covers a second surface opposing the first surface of the trailing platform.

F. The shaving cartridge of any one of paragraphs A-E wherein the housing has a cover surface extending over the first pocket.

G. The shaving cartridge of claim F wherein the housing has a cover surface extending over the second pocket.

H. The shaving cartridge of any one of paragraphs A-G wherein the window is positioned between the first pocket and the second pocket.

I. The shaving cartridge of any one of paragraphs A-H wherein the shaving aid composition of an upper skin contacting surface of the trailing skin bar is completely exposed.

J. The shaving cartridge of any one of paragraphs A-I wherein a volume of the shaving aid composition within at least one of the first pocket and the second pocket is 50 mm³ to about 200 mm³.

K. The shaving cartridge of any one of paragraphs A-J wherein the shaving aid composition in at least the first pocket and the second pocket is exposed.

L. The shaving cartridge of any one of paragraphs A-K wherein the housing has a cover surface extending over the first pocket and the shaving aid composition is exposed opposite the cover surface of the first pocket.

M. The shaving cartridge of paragraph L wherein the housing has a cover surface extending over the second pocket and the shaving aid composition is exposed opposite the cover surface of the second pocket.

N. The shaving cartridge of any one of paragraphs A-M wherein the trailing platform defines a plurality of through openings that extend in a direction substantially perpendicular to the direction of the first through hole and the shaving aid composition is formed within the plurality of through openings.

O. The shaving cartridge of any one of paragraphs A-N further comprising a leading skin bar having the shaving aid composition mounted to a first surface of a leading platform of the housing, wherein the shaving aid composition extends from the first surface of the leading skin bar into a second through hole of the first pocket, into a second through hole of the second pocket and into the first and second pockets, wherein the second through holes extend in the direction between the guard and the cap.

P. A shaving cartridge comprising a housing defining a first pocket, a second pocket and a window dimensioned to receive one or more blades, the housing having a leading platform; a blade mounted within the window; a guard in front of the blade; a cap behind the blade; a leading skin bar comprising a shaving aid composition mounted to a first surface of the leading platform, the shaving aid composition extends from the first surface into a second through hole of the first pocket, and into the first pocket, wherein the second through hole extends in a direction between the guard and the cap.

Q. The shaving cartridge of paragraph P wherein the shaving aid composition extends from the first surface into a second through hole of the second pocket and into the second pocket.

R. The shaving cartridge of any one of paragraphs P-Q wherein the leading platform defines a plurality of through openings that extend in a direction substantially perpendicular to the direction of the first through holes.

S. The shaving cartridge of any one of paragraphs P-R wherein the guard and the cap define a shaving plane and the shaving aid composition does not cover a first surface of the leading platform that faces away from the shave plane.

T. The shaving cartridge of paragraph S wherein the shaving aid composition covers a second surface opposing the first surface of the leading platform.

U. The shaving cartridge of any one of paragraphs P-R wherein the housing has a cover surface extending over the first pocket.

V. The shaving cartridge of paragraph U wherein the housing has a cover surface extending over the second pocket.

W. The shaving cartridge of any one of paragraphs P-V wherein the window is positioned between the first pocket and the second pocket.

X. The shaving cartridge of any one of paragraphs P-W wherein the shaving aid composition of an upper skin contacting surface of the leading skin bar is completely exposed.

Y. The shaving cartridge of any one of paragraphs P-X wherein a volume of the shaving aid composition within at least one of the first pocket and the second pocket is 50 mm³ to about 200 mm³.

Z. The shaving cartridge of any one of paragraphs P-Y wherein the shaving aid composition in at least the first pocket and the second pocket is exposed.

AA. The shaving cartridge of any one of paragraphs P-Z wherein the housing has a cover surface extending over the first pocket and the shaving aid composition is exposed opposite the cover surface of the first pocket.

BB. The shaving cartridge of paragraph AA wherein the housing has a cover surface extending over the second pocket and the shaving aid composition is exposed opposite the cover surface of the second pocket.

CC. The shaving cartridge of any one of paragraphs P-BB wherein the leading platform defines a plurality of through openings that extend in a direction substantially perpendicular to the direction of the second through hole and the shaving aid composition is formed within the plurality of through openings.

DD. The shaving cartridge of any one of paragraphs P-CC wherein the leading platform is rigid.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”. Furthermore, dimensions should not be held to an impossibly high standard of metaphysical identity that does not allow for discrepancies due to typical manufacturing and measuring tolerances. Therefore, the term “about” should be interpreted as being within typical manufacturing and measuring tolerances.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving cartridge comprising:
a housing defining a first pocket, a second pocket and a window dimensioned to receive one or more blades, the housing having a leading platform;
a blade mounted within the window;
a guard in front of the blade;
a cap behind the blade;
a leading skin bar comprising a shaving aid composition mounted to a first surface of the leading platform, the shaving aid composition extends from the first surface into a second through hole of the first pocket, and into the first pocket, wherein the second through hole extends in a direction between the guard and the cap.

2. The shaving cartridge of claim 1 wherein the shaving aid composition extends from the first surface into a second through hole of the second pocket and into the second pocket.

3. The shaving cartridge of claim 1 wherein the leading platform defines a plurality of through openings that extend in a direction substantially perpendicular to the direction of the first through holes.

4. The shaving cartridge of claim 1 wherein the guard and the cap define a shaving plane, and the shaving aid composition does not cover a first surface of the leading platform that faces away from the shave plane.

5. The shaving cartridge of claim 4 wherein the shaving aid composition covers a second surface opposing the first surface of the leading platform.

6. The shaving cartridge of claim 1 wherein the housing has a cover surface extending over the first pocket.

7. The shaving cartridge of claim 6 wherein the housing has a cover surface extending over the second pocket.

8. The shaving cartridge of claim 1 wherein the window is positioned between the first pocket and the second pocket.

9. The shaving cartridge of claim 1 wherein the shaving aid composition of an upper skin contacting surface of the leading skin bar is completely exposed.

10. The shaving cartridge of claim 1 wherein a volume of the shaving aid composition within at least one of the first pocket and the second pocket is 50 mm³ to about 200 mm³.

11. The shaving cartridge of claim 1 wherein the shaving aid composition in at least the first pocket and the second pocket is exposed.

12. The shaving cartridge of claim 1 wherein the housing has a cover surface extending over the first pocket and the shaving aid composition is exposed opposite the cover surface of the first pocket.

13. The shaving cartridge of claim 12 wherein the housing has a cover surface extending over the second pocket and the shaving aid composition is exposed opposite the cover surface of the second pocket.

14. The shaving cartridge of claim 1 wherein the leading platform defines a plurality of through openings that extend in a direction substantially perpendicular to the direction of the second through hole and the shaving aid composition is formed within the plurality of through openings.

15. The shaving cartridge of claim 1 wherein the leading platform is rigid.

16. A shaving cartridge comprising:
a housing defining a first pocket, a second pocket and a window dimensioned to receive one or more blades, the housing having a trailing platform;
a blade mounted within the window;
a guard in front of the blade;
a cap behind the blade;
a trailing skin bar comprising a shaving aid composition mounted to a first surface of the trailing platform, the shaving aid composition extends from the first surface into a first through hole of the first pocket, and into the first pocket, wherein the first through hole extends in a direction between the guard and the cap.

17. The shaving cartridge of claim 16 wherein the shaving aid composition extends from the first surface into a first through hole of the second pocket and into the second pocket.

18. The shaving cartridge of claim 16 wherein the trailing platform defines a plurality of through openings that extend in a direction substantially perpendicular to the direction of the first through holes.

19. The shaving cartridge of claim 16 wherein the guard and the cap define a shaving plane, and the shaving aid composition does not cover a first surface of the trailing platform that faces away from the shave plane.

20. The shaving cartridge of claim 16 wherein the shaving aid composition covers a second surface opposing the first surface of the trailing platform.
